(19) United States
(12) Patent Application Publication
(10) Pub. No.: US 2011/0139077 A1
(43) Pub. Date: Jun. 16, 2011

(54) GRAVITY INDUCED WILD GAME FEEDING DEVICE

(76) Inventors: Larry Wayne Gray, Ferriday, LA (US); Christopher Teal Gray, Dubach, LA (US)

(21) Appl. No.: 13/033,395

(22) Filed: Feb. 23, 2011

Related U.S. Application Data
(62) Division of application No. 11/944,349, filed on Nov. 21, 2007.
(60) Provisional application No. 60/867,048, filed on Nov. 22, 2006.

(51) Int. Cl. A01K 5/00

(52) U.S. Cl. 119/51.11; 119/51.01

(57) ABSTRACT

A method for enabling the dispensation of feed to large four-legged game, the method including the steps of providing an apparatus as further described herein, burying the bottom end portion of the apparatus at a depth so that the restricted opening is disposed at least two feet above ground level, placing feed into the elongated hollow member of the apparatus such that the feed contacts the primary internal support member and is retained in the elongated hollow member, and dispensing feed through the restricted opening of the apparatus when the feed is dislodged by agitation from large four-legged game.

### REFERENCE TO RELATED APPLICATIONS

This is a divisional of co-pending U.S. application Ser. No. 11/944,349, filed Nov. 21, 2007, which in turn claims the benefit and priority of U.S. Provisional Application No. 60/867,048, filed Nov. 22, 2006, the disclosures of which are incorporated herein by reference.

### TECHNICAL FIELD

This invention relates generally to the field of apparatus for dispensing feed to large four-legged game.

### BACKGROUND

Avid outdoorsmen and nature enthusiasts have used feeding devices to attract wild game to certain areas of interest for observation and/or hunting purposes. Typically, feeders commonly used allow for food to be dispensed to the ground or to a trough in order for the game to feed.

### THE INVENTION

It has been found that many of the previously developed feeders used for these purposes permit large amounts of feed to be eaten by wild pest scavengers, such as raccoons and squirrels. The amount of feed lost to these scavengers is costly and requires frequent refilling of the feeder. Also, many feeders known heretofore include mechanical means to dispense the feed, thereby creating noise foreign to the natural environment, which consequently frightens the wild game from approaching the feeder or causing the wild game to leave the feeder once the wild game approaches. In addition, the use of mechanical parts subjects such feeders to increased maintenance requirements, which requires more frequent observations of the feeder. Furthermore, another disadvantage of the previously known feeders is the need for a support structure to retain or support the feeder while the game feed from the device. The need for a support structure, such as a tree, can limit the areas in which a feeder may be placed.

The present invention overcomes the shortcomings of the previously known feeding systems by providing a unique and highly useful combination of elements and/or steps, requiring a minimum number of functioning parts, at a reasonable cost to manufacture, while employing readily available materials. The invention provides a simple, efficient, and inexpensive solution to the need for a quiet, economical, and convenient way to dispense feed to large four-legged game such as deer, elk, moose, black bear, and the like, when permitted by law, while minimizing the amount of feed lost to wild scavenging pests.

Accordingly, an embodiment of this invention is an apparatus for dispensing feed to large four-legged game, the apparatus comprising an elongated hollow member comprising an outer sidewall and an inner sidewall, the elongated hollow member further forming a restricted opening in a mid-portion of the elongated hollow member, the restricted opening being sized and configured to substantially retain the feed within the elongated hollow member until the feed is dislodged by agitation from the large four-legged game, a cover detachably attachable to a top end portion of the elongated hollow member, and a primary internal support member, wherein the primary internal support member is attached to the inner sidewall of the elongated hollow member and adjacent to the restricted opening, the elongated hollow member being sized and configured such that a bottom end portion of the elongated hollow member, when the elongated hollow member is orientated vertically, may be buried beneath the surface of the ground, thereby securely holding the elongated hollow member in a fixed and rigid position and disposing the restricted opening above ground level.

Another embodiment of this invention is an apparatus for dispensing feed to large four-legged game, the apparatus comprising an elongated hollow member comprising an outer sidewall and an inner sidewall, the elongated hollow member further forming a restricted opening in a mid-portion of the elongated hollow member, the restricted opening being sized and configured to substantially retain the feed within the elongated hollow member until the feed is dislodged by agitation from the large four-legged game, a primary internal support member, wherein the primary internal support member is attached to the inner sidewall of the elongated hollow member and adjacent to the restricted opening, and a hollow storage member comprising a hollow storage member first end portion and a hollow storage member second end portion wherein the hollow storage member second end portion is detachably attached to a top end portion of the elongated hollow member in a manner such that feed may be transferred from the hollow storage member to the elongated hollow member, the elongated hollow member being sized and configured such that a bottom end portion of the elongated hollow member when orientated vertically may be buried beneath the surface of the ground, thereby securely holding the elongated hollow member in a fixed and rigid position.

Further, another embodiment of this invention is an apparatus for dispensing feed to large four-legged game, the apparatus comprising an elongated hollow member comprising an outer sidewall and an inner sidewall, the elongated hollow member further forming a restricted opening in a bottom end portion of the elongated hollow member, the restricted opening being sized and configured to substantially retain the feed within the elongated hollow member until the feed is dislodged by agitation from the large four-legged game, a primary internal support member, wherein the primary internal support member is attached to the inner sidewall of the elongated hollow member and adjacent to the restricted opening, and a hollow storage member comprising a hollow storage member first end portion and a hollow storage member second end portion wherein the hollow storage member second end portion is detachably attached to a top end portion of the elongated hollow member in a manner such that feed may be transferred from the hollow storage member to the elongated hollow member, the elongated hollow member being sized and configured such that the elongated hollow member is collinearly aligned with the hollow storage member and substantially vertically disposed with respect to the ground.

Still yet, another embodiment of this invention is a method for enabling the dispensation of feed to large four-legged game, the method comprising the steps of providing an apparatus for dispensing feed to large four-legged game, the apparatus comprising an elongated hollow member comprising an outer sidewall and an inner sidewall, the elongated hollow member further forming a restricted opening in a mid-portion of the elongated hollow member, the restricted opening being sized and configured to substantially retain the feed within the elongated hollow member until the feed is dislodged by agitation from the large four-legged game, a cover detachably attachable to a top end portion of the elongated hollow member, and a primary internal support member, wherein the primary internal support member is attached to the inner sidewall of the elongated hollow member and adjacent to the restricted opening, the elongated hollow member being sized and configured such that a bottom end portion of the elongated hollow member, when the elongated hollow member is orientated vertically, may be buried beneath the surface of the ground, thereby securely holding the elongated hollow member in a fixed and rigid position and disposing the restricted opening above ground level, burying the bottom end portion at a depth so that the restricted opening is disposed at least two feet above ground level, placing feed into the elongated hollow member such that the feed contacts the primary internal support member and is retained in the elongated hollow member, and dispensing feed through the restricted opening when the feed is dislodged by agitation from the large four-legged game.

Another embodiment of this invention is a method for enabling the dispensation of feed to large four-legged game, the method comprising the steps of providing an apparatus for dispensing feed to large four-legged game, the apparatus comprising an elongated hollow member comprising an outer sidewall and an inner sidewall, the elongated hollow member further forming a restricted opening in a bottom end portion of the elongated hollow member, the restricted opening being sized and configured to substantially retain the feed within the elongated hollow member until the feed is dislodged by agitation from the large four-legged game, a primary internal support member, wherein the primary internal support member is attached to the inner sidewall of the elongated hollow member and adjacent to the restricted opening, and a hollow storage member comprising a hollow storage member first end portion and a hollow storage member second end portion wherein the hollow storage member second end portion is detachably attached to a top end portion of the elongated hollow member in a manner such that feed may be transferred from the hollow storage member to the elongated hollow member, the elongated hollow member being sized and configured such that the elongated hollow member is collinearly aligned with the hollow storage member and substantially vertically disposed with respect to the ground, placing feed into the hollow storage member such that the feed contacts the primary internal support member and is retained in the elongated hollow member, and dispensing feed through the restricted opening when the feed is dislodged by agitation from the large four-legged game.

These and other embodiments and features of this invention will be still further apparent from the ensuing drawings, detailed description and appended claims.

### BRIEF DESCRIPTION OF THE DRAWINGS

FIG. 1 is an exploded perspective view of an apparatus for dispensing feed to large four-legged game illustrating an elongated hollow member forming a restricted opening consistent with one embodiment of the present invention.

FIG. 2 is a top plan view of an apparatus for dispensing feed to large four-legged game in accordance with the embodiment of FIG. 1.

FIG. 3 is a perspective view of an apparatus for dispensing feed to large four-legged game partially buried underneath the ground in accordance with the embodiment of FIG. 1.

FIG. 4 is a perspective view of an apparatus for dispensing feed to large four-legged game consistent with another embodiment of the present invention.

FIG. 5 is a cross-sectional view of an apparatus for dispensing feed to large four-legged game partially buried underneath the ground in accordance with the embodiment of FIG. 4.

FIG. 6 is a perspective view of an apparatus for dispensing feed to large four-legged game consistent with another embodiment of the present invention.

FIG. 7 is a perspective view of an apparatus for dispensing feed to large four-legged game consistent with another embodiment of the present invention.

FIG. 8 is a perspective view of an apparatus for dispensing feed to large four-legged game consistent with another embodiment of the present invention.

FIG. 9 is a perspective view of an apparatus for dispensing feed to large four-legged game consistent with another embodiment of the present invention.

FIG. 10 is a perspective view of an apparatus for dispensing feed to large four-legged game consistent with another embodiment of the present invention.

FIG. 11 is a perspective view of an apparatus for dispensing feed to large four-legged game consistent with another embodiment of the present invention.

FIG. 12 is a cross-sectional view of a primary internal support member attached to an inner surface of an elongated hollow member in accordance with the embodiment of FIG. 1.

FIG. 13 is a cross-sectional view of a primary internal support member attached to an inner surface of an elongated hollow member consistent with another embodiment of the present invention.

FIG. 14 is a perspective view of a cover detachably attachable to an elongated hollow member consistent with another embodiment of the present invention.

FIG. 15 is a perspective view of a cover detachably attachable to an elongated hollow member in accordance with the embodiment of FIG. 1.

FIG. 16 a cross-sectional view of an apparatus for dispensing feed to large four-legged game the ground consistent with another embodiment of the present invention.

Like reference numbers or letters are used in the figures to reference like parts or components amongst the several figures.

### FURTHER DETAILED DESCRIPTION OF THE INVENTION

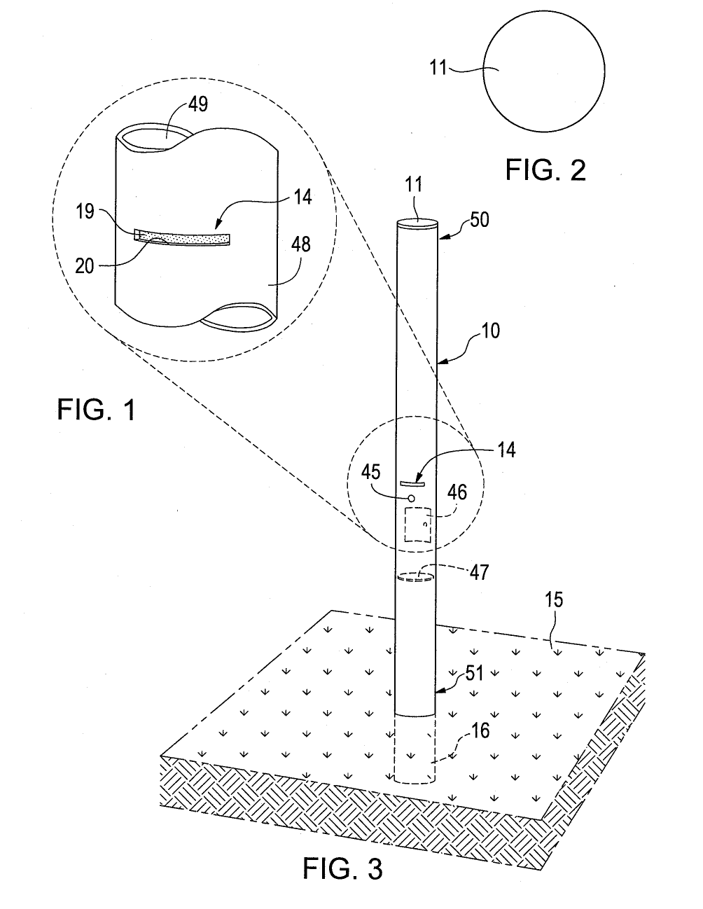

Referring now descriptively to the drawings, the attached figures illustrate the device according to the present invention. FIGS. 1-3 illustrate one embodiment of the invention comprising an elongated hollow member 10 which in turn comprises an outer sidewall 48 and an inner sidewall 49, the elongated hollow member 10 further forming a restricted opening 14 in a mid-portion of the elongated hollow member 10, the restricted opening 14 being sized and configured to substantially retain the feed 19 within the elongated hollow member 10 until the feed 19 is dislodged by agitation from the large four-legged game (not shown), a cover 11 detachably attachable to a top end portion 50 of the elongated hollow member 10, and a primary internal support member (not shown), wherein the primary internal support member (not shown) is attached to the inner sidewall 49 of the elongated hollow member 10 and adjacent to the restricted opening 14, the elongated hollow member 10 being sized and configured such that a bottom end portion 51 of the elongated hollow member 10, when the elongated hollow member 10 is orientated vertically, may be buried 16 beneath the surface of the ground 15, thereby securely holding the elongated hollow member 10 in a fixed and rigid position and disposing the restricted opening 14 above ground level.

More specifically, the embodiment of the present invention as shown in FIGS. 1-3 comprises an elongated hollow member, illustrated as a generally vertical cylinder or tube shaped main body housing 10, having a removably attached cover in the form of a top surface 11, a bottom surface (not shown), a fixably attached primary internal support member (not shown), and a restricted opening shown as a horizontal front feed access opening 14. The main body housing 10 is positioned directionally vertical so that the bottom surface and a portion of the main body housing 10 can be buried or embedded below the surface of the ground 15, thereby securely holding the main body housing 10 in a fixed and rigid position, with the amount of the main body housing 10 to be buried 16 or embedded in the ground being proportionately dependant on the overall length of the main body housing 10. The horizontal front feed access opening 14 is positioned generally in the lower middle region of the tube shaped main body housing 10. The restricted opening further being sized and configured to be disposed at least two feet from the ground when the main body housing is buried in the ground and, more preferably, at least three feet from the ground when the main body housing is buried in the ground.

Optionally, as shown in FIG. 3, a secondary internal support member 47 may be attached to the inner sidewall 49 of the elongated hollow member 10 below the horizontal opening 14. An aperture 45 formed from the elongated hollow member and a fixably attached access panel 46 may be included to allow access to any objects placed on the secondary internal support member 47. Such objects may include a timing device, an image recording means, or a scent or odor material for attracting large four-legged game. Such examples are nonlimiting as other objects may be placed on the secondary internal support member 47 without deviating from the scope and spirit of the present invention. In certain embodiments, the elongated hollow member may form additional apertures below the horizontal opening to allow access to objects placed on the secondary internal support member or to allow for operation of objects placed on the secondary internal support member.

Further, although the restricted opening is illustrated as a horizontal opening in the particular embodiment depicted in FIGS. 1-3, the restricted opening may be of any shape or form wherein the opening is large enough for feed to be dislodged from the opening when the feed is agitated by large four-legged game but small enough to retain the feed in the elongated hollow member when no agitation is present from large four-legged game. In a preferred embodiment, restricted opening may be a horizontal or vertical opening and between two and six inches in length and less than one inch in width. It should be appreciated that the disposition, shape, size or configuration of the restricted opening may vary without deviating from the scope and spirit of the present invention.

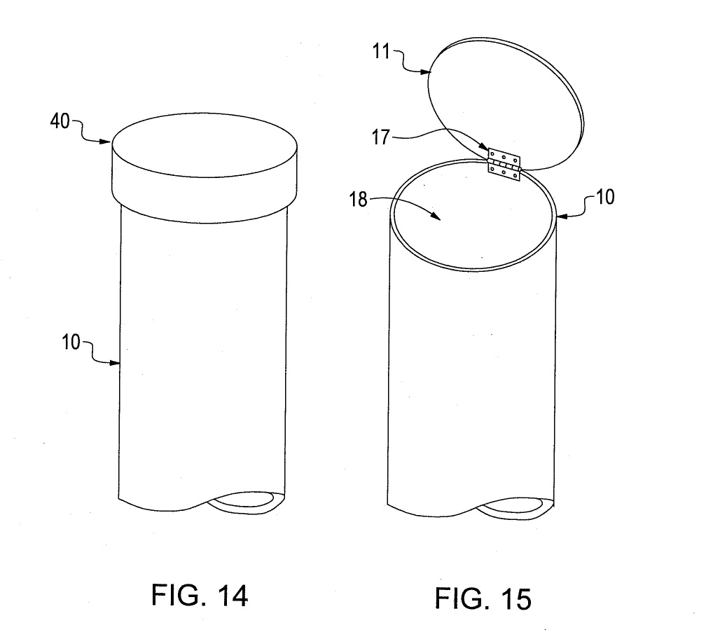

As shown in FIGS. 14-15, the removably attached top surface 11 of the main body housing may be opened, by means of hinges 17 attached to both the removable top surface 11 and the main body housing 10, or removed, by means including the twisting off of a threaded cap 40, or the unscrewing of a plug cap or other capping device that performs the same function and should be considered as obvious and apparent to the disclosure, creating a top access opening 18 into the main body housing 10, whereby the user can insert articles including feed 19.

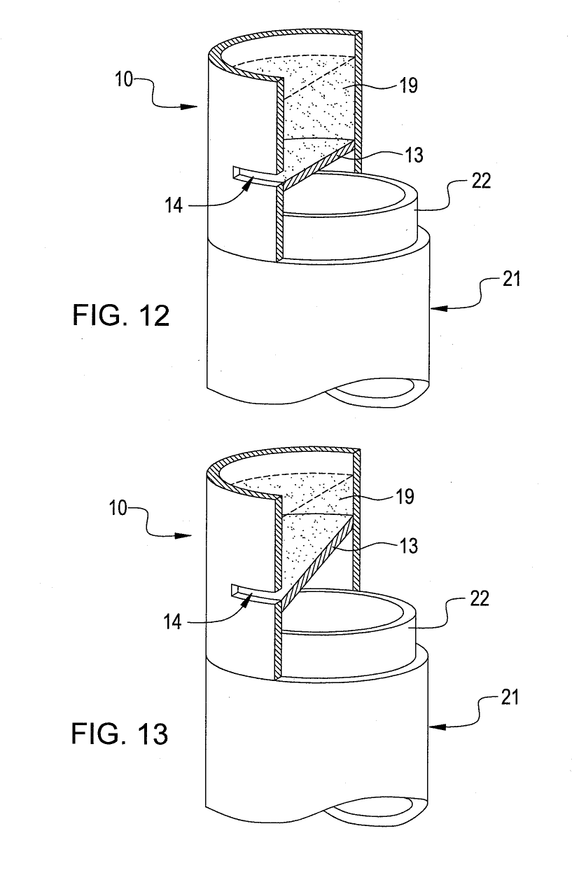

Turning now to FIG. 12-13, once inserted inside housing 10, feed 19 rests on the top surface of the primary internal support member illustrated as a fixably attached interior platform shelf 13, thereby disposing feed 19 substantially in the lower middle to upper portion of the device. In one particular embodiment, the bottom surface 20 of the horizontal opening 14 and the top surface of the fixably attached interior shelf 13 form a contiguous surface, whereby feed 19 is urged by gravity towards the front feed access opening 14.

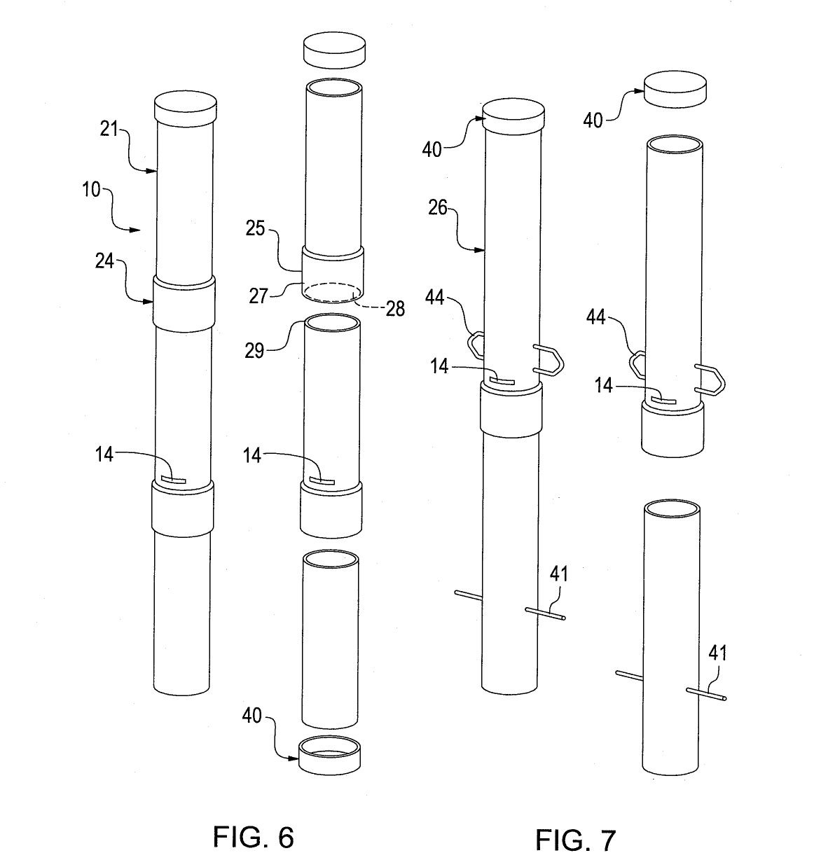

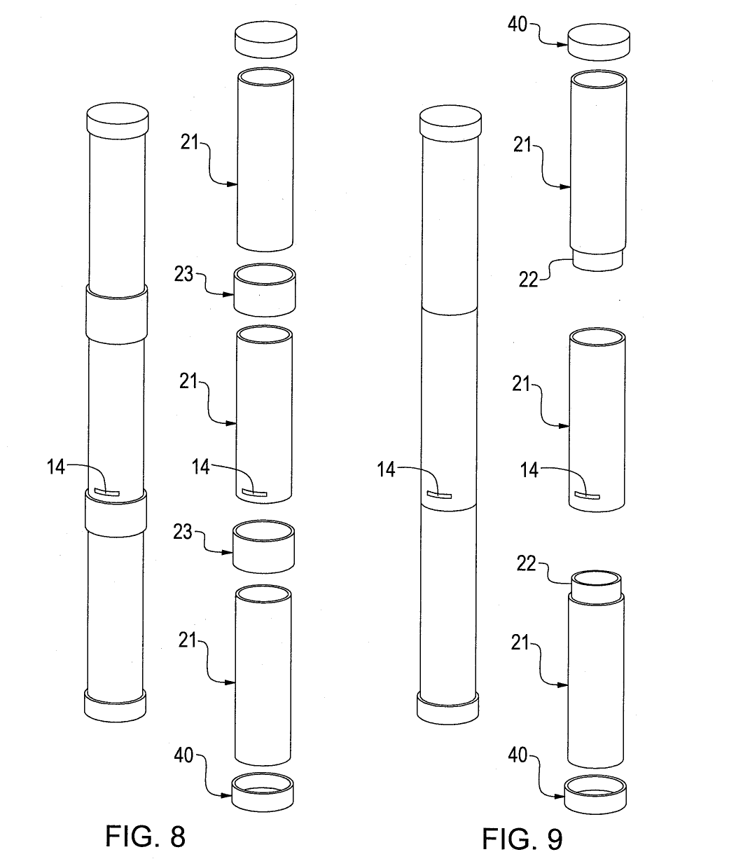

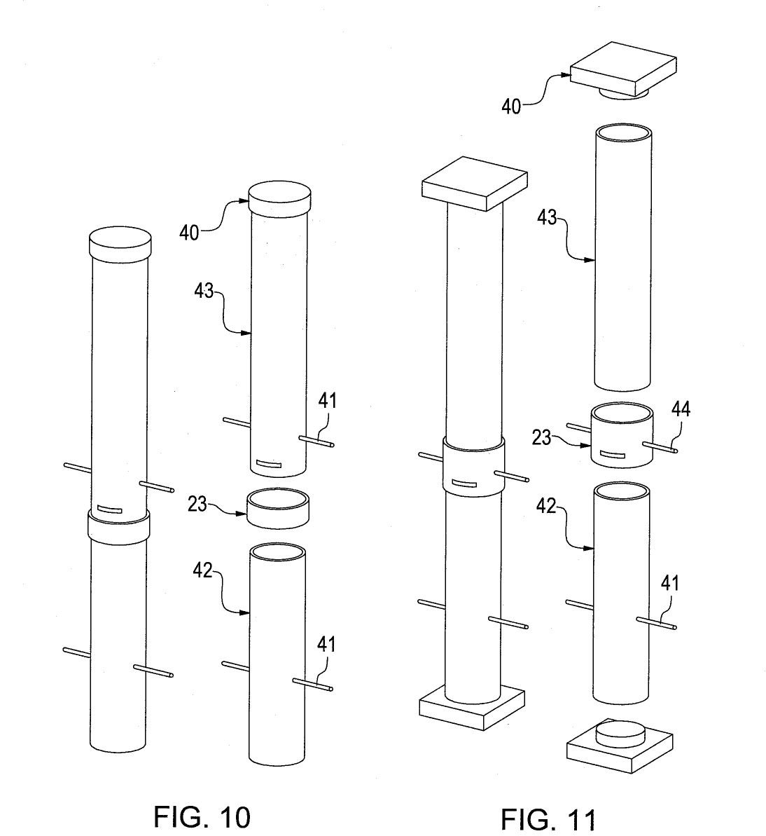

Looking now at FIGS. 6-11, it is to be further understood that the main body housing 10 may be comprised of one or a multitude of sections 21, whereby the sections may be coupled together in a variety of coupling means including an interior sleeve coupler 22, an exterior collar coupler 23, and a flange coupler 24 wherein the flange 25 is of the same embodiment as the housing section 26, whereby the exterior portion 27 of flange 25 is of a diameter that is greater than that of the main body housing section 26, and the interior portion 28 of flange 25 is of a diameter that allows the flange to receive the end portion 29 of another housing section. Any other main body housing section connection method, which performs the same function, is to be considered as obvious and apparent to the present invention disclosed herein. Additionally, either the main body device housing, or the coupling section 21,43, may contain foot pegs 41 and or handles 44 for the purpose of lifting the upper feed holding section 43 off of the lower ground embedded, stationary section 42, while holding the ground embedded lower stationary section 42 firmly in position. The main body sections and or cap may include a locking device for security purposes.

It is further intended that the device may employ the use of a timing device, including but not limited to, one or a multitude of photocell switches disposed in various locations on the main body housing, to activate a feed opening barrier, which is disposed on the interior or exterior of the main body housing in close proximity to the generally rectangular, horizontal feed access opening. When activated by increased sunlight, the photocell switches will open the barrier plate, thereby allowing access to the feed contained within the main body housing. Once the sunlight is sufficiently diminished, the photocell switches will then deactivate, thereby closing the barrier plate and preventing access to the feed.

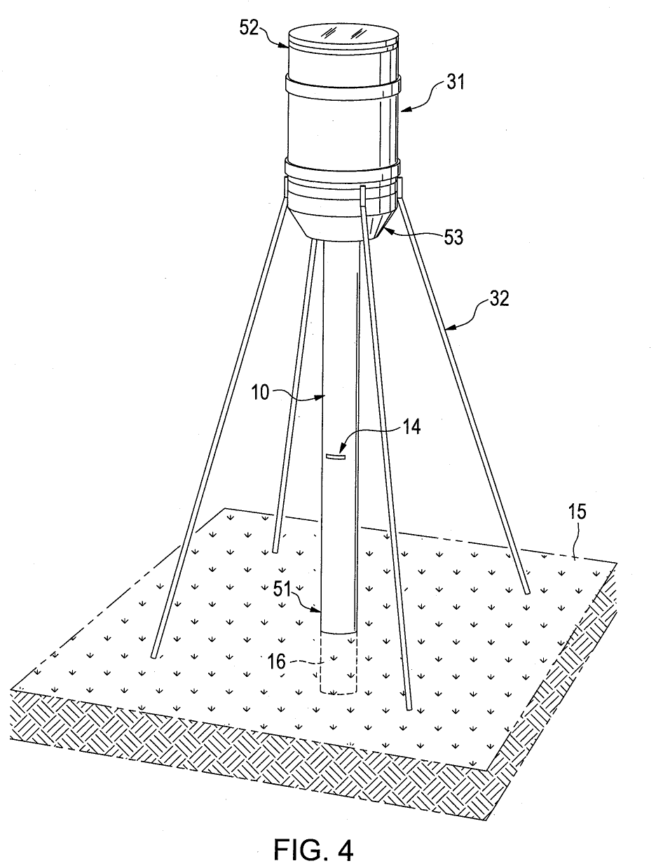

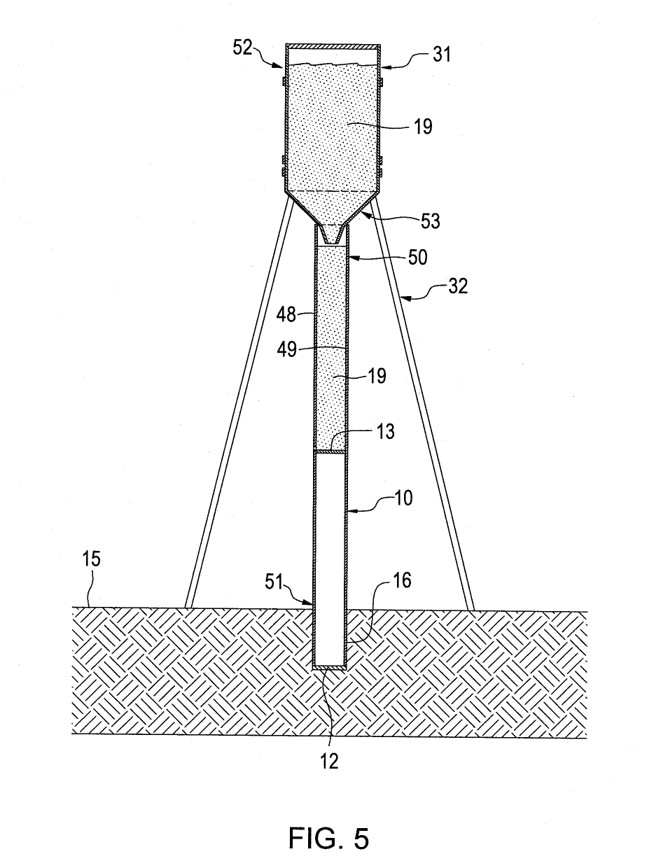

As seen in FIGS. 4 and 5, the present invention in an alternate embodiment generally comprises an elongated hollow member 10 comprising an outer sidewall 48 and an inner sidewall 49, the elongated hollow member 10 further forming an restricted opening 14 in a mid-portion of the elongated hollow member 10, the restricted opening 14 being sized and configured to substantially retain the feed 19 within the elongated hollow member 10 until the feed 19 is dislodged by agitation from the large four-legged game (not shown), a primary internal support member 13, wherein the primary internal support member 13 is attached to the inner sidewall 49 of the elongated hollow member 10 and adjacent to the restricted opening 14, and a hollow storage member 31 comprising a hollow storage member first end portion 52 and a hollow storage member second end portion 53 wherein the hollow storage member second end portion 53 is detachably attached to a top end portion 50 of the elongated hollow member 10 in a manner such that feed 19 may be transferred from the hollow storage member 31 to the elongated hollow member 10, the elongated hollow member 10 being sized and configured such that a bottom end portion 51 of the elongated hollow member 10 when orientated vertically may be buried 16 beneath the surface of the ground 15, thereby securely holding the elongated hollow member 10 in a fixed and rigid position.

More specifically, the alternate embodiment comprises the same elongated hollow member shown as a generally vertical cylinder or tube shaped main body housing 10, having a removably attached cover in the form of top surface (not shown), an optional bottom surface 12, fixably attached primary internal support member shown as an interior platform shelf 13, a restricted opening in the form of a horizontal front feed access opening 14, and additionally, a hollow storage member illustrated as secondary feed storage tank housing 31 with at least one storage support member in the form of supports 32 and an optional timing device, whereby the main tube body housing 10 is positioned directionally vertical so that the bottom surface 12 and a portion of the main body housing 10 can be buried or embedded below the surface of the ground, thereby securely holding the main body housing 10 in a fixed and rigid position, with the amount of the main body housing to be buried or embedded in the ground 15 being proportionately dependant on the overall length of the main body housing 10, then having the secondary feed storage tank housing 31 placed directionally above the open top end of the tube shaped main body housing 10, whereby the feed 19 from the secondary feed storage tank housing 31 is urged by gravity downward and funneled directly into the open top end of the tube shaped main body housing 10, thereby increasing the feed capacity of the feeding device which in turn reduces the number of times that the device will need to be refilled, additionally, this configuration will convert a mechanical feeding device into a quieter, more efficient gravity induced feeding device. Optionally, the feed which is dispensed from the secondary feed storage tank housing can be regulated by means of a timing device which will restrict the gravity induced flow of feed, out of the secondary feed storage tank, until the timing device is activated, at pre set intervals, thereby opening the restricting barrier, which allows the gravity induced flow of feed to resume until the timing device activates and closes the restrictive barrier thereby halting the flow of feed. Optionally, the restrictive feed barrier may be opened or closed by means of a timing device triggered by photocell switches which are activated by increased sunlight, the photocell switches will open the barrier plate, thereby allowing the gravity induced flow of feed to resume. Once the sunlight is sufficiently diminished, the photocell switches will then deactivate, thereby closing the barrier plate and thereby halting the flow of feed. Additionally, all feed flow or feed access may be stopped or started, or opened or closed, with or without a timing device and or by manually opening or closing the restrictive feed barriers.

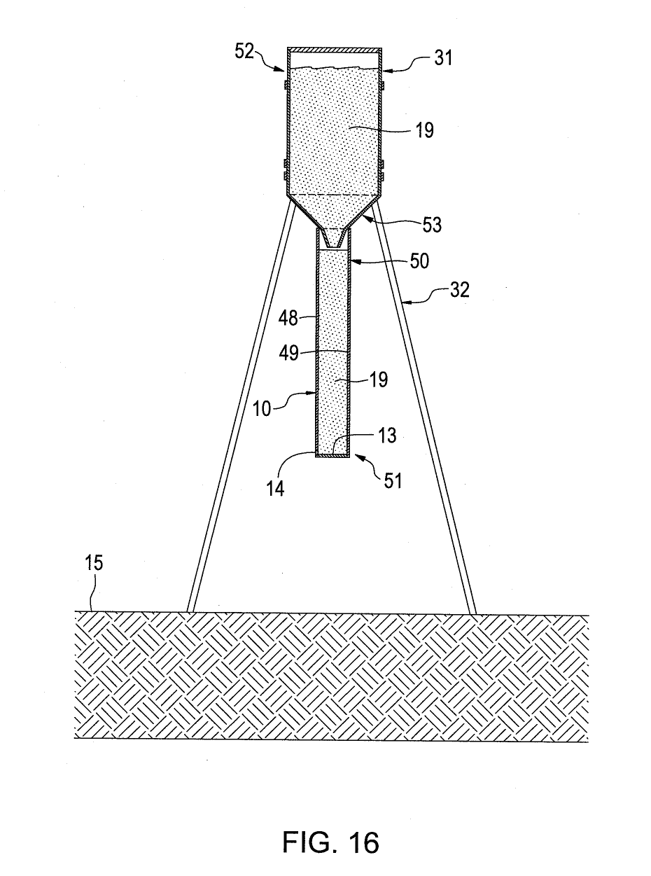

Looking now at FIG. 16, another alternate embodiment of the present invention generally comprises an elongated hollow member 10 comprising an outer sidewall 48 and an inner sidewall 49, the elongated hollow member 10 further forming an restricted opening 14 in a bottom end portion 51 of the elongated hollow member 10, the restricted opening 14 being sized and configured to substantially retain the feed 19 within the elongated hollow member 10 until the feed 19 is dislodged by agitation from the large four-legged game (not shown), a primary internal support member 13, wherein the primary internal support member 13 is attached to the inner sidewall 49 of the elongated hollow member 10 and adjacent to the restricted opening 14, and a hollow storage member 31 comprising a hollow storage member first end portion 52 and a hollow storage member second end portion 53 wherein the hollow storage member second end portion 53 is detachably attached to a top end portion 50 of the elongated hollow member 10 in a manner such that feed 19 may be transferred from the hollow storage member 31 to the elongated hollow member 10, the elongated hollow member 10 being sized and configured such that the elongated hollow member 10 is collinearly aligned with the hollow storage member 31 and substantially vertically disposed with respect to the ground 15.

More specifically, the alternate embodiment comprises a similar elongated hollow member shown as a generally vertical cylinder or tube shaped main body housing 10. In this embodiment, the fixably attached primary internal support member shown as an interior platform shelf 13 and a restricted opening in the form of a horizontal front feed access opening 14 are found at the bottom end portion 51 of the elongated hollow member. Additionally, the alternate embodiment comprises a hollow storage member illustrated as secondary feed storage tank housing 31 with at least one storage support member in the form of supports 32. The elongated hollow member is co-linearly aligned with the hollow storage member 31 and substantially vertically disposed with respect to the ground 15.

Further, in another embodiment of the present invention, the elongated hollow member may be attached to the support member without the hollow storage member attached to the top end portion of the elongated hollow member. In this particular embodiment, feed may be added directly to top end portion of the elongated hollow member before or while the elongated hollow member is attached to the support member. The elongated hollow member may be attached to an elevated man-made or natural support structure in such a manner that the elongated hollow member may hang from the support structure thereby disposing the elongated hollow member vertically with respect to the ground and the restricted opening a distance at least two feet from the ground. More preferably, the restricted opening may be a distance at least three feet from the ground. The elongated hollow member may be attached to the elevated support structure by various attachment means, including rope, chain, wire, cable, bolts, screws, or the like.

In a particular embodiment, the means for controlling the movement of the barrier plate may include the timing device being electronically coupled to a motor whereby the motor is operatively connected to the barrier plate. A signal by the timing device may be sent to the motor whereby the motor causes gears to rotate the barrier plate into a closed or opened position with respect to the restricted opening thereby controlling access to the feed. Other actuating means for controlling the movement of the barrier plate may be used without varying from the scope and spirit of the invention.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation in its practice. Thus, it will be appreciated that those of ordinary skill in the art, having the benefits of the present disclosure, will be capable of envisioning other variations of the specific embodiments illustrated above, and all such variations readily apparent to those of ordinary skill in the art having the benefit of this disclosure are intended to be within the spirit and scope of the present invention and the appended claims.

That which is claimed is:

1. A method for enabling the dispensation of feed to large four-legged game, the method comprising the steps of
providing an apparatus comprising
(i) an elongated hollow member comprising an outer sidewall and an inner sidewall, the elongated hollow member further forming a restricted opening in a mid-portion of the elongated hollow member, the restricted opening being sized and configured to substantially retain the feed within the elongated hollow member until the feed is dislodged by agitation from the large four-legged game;
(ii) a cover detachably attachable to a top end portion of the elongated hollow member; and
(iii) a primary internal support member, wherein the primary internal support member is attached to the inner sidewall of the elongated hollow member and adjacent to the restricted opening,
the elongated hollow member being sized and configured such that a bottom end portion of the elongated hollow member, when the elongated hollow member is orientated vertically, may be buried beneath the surface of the ground, thereby securely holding the elongated hollow member in a fixed and rigid position and disposing the restricted opening above ground level,
burying the bottom end portion at a depth so that the restricted opening is disposed at least two feet above ground level,
placing feed into the elongated hollow member such that the feed contacts the primary internal support member and is retained in the elongated hollow member, and
dispensing feed through the restricted opening when the feed is dislodged by agitation from the large four-legged game.

2. The method according to claim 1 further comprising burying the bottom end portion at a depth so that the restricted opening is disposed at least three feet above ground level.

3. The method according to claim 1, wherein the step of dispensing feed through the restricted opening when the feed is dislodged by agitation from the large four-legged game is regulated by a timer.
